(19) United States
(12) Patent Application Publication
(10) Pub. No.: US 2013/0041772 A1
(43) Pub. Date: Feb. 14, 2013

(54) Marketplace for Executive-Level Meeting Time

(71) Applicant: John W. AGGREY, Washington, DC (US)

(72) Inventor: John W. AGGREY, Washington, DC (US)

(73) Assignee: BizGravity, LLC

(21) Appl. No.: 13/207,322

(22) Filed: Aug. 10, 2011

(51) Int. Cl. G06Q 30/00

(52) U.S. Cl. 705/26.3; 705/26.43

(57) ABSTRACT

Various systems, methods, and computer program products are described for mediating sales between a buyer and a seller of meeting times. For example, a method may include receiving an indication of a meeting for sale and a sale parameter. The meeting for sale includes a meeting with a party of interest for a specified period of time and the sale parameter describes the meeting for sale. The method may include communicating the meeting for sale and the sale parameter. The method may include receiving an offer to purchase the meeting for sale. The method may include determining whether the offer satisfies the sale parameter. The method may include facilitating the meeting with the party of interest when the offer satisfies the sale parameter.

### FIELD OF THE INVENTION

The disclosure relates to providing a marketplace for meetings and in particular to a marketplace for bidding on and selling meeting times with individuals through an online portal that provides social networking and electronic collaboration among like professionals.

### BACKGROUND OF THE INVENTION

Corporations from startup to large businesses have a continuous and increasing need for quality business development and sales activities. An integral part of the process for such resources includes the “first meeting” between a Business Development Manager (“BDM”) and a targeted key stakeholder within a prospective customer organization. Conventional Customer Relationship Management (“CRM”) systems and social media tools offer the benefits of managing contact information but fail to get the prospect to commit to a meeting with the BDM. Typically, BDMs rely on a variety of traditional marketing vehicles including direct mail, tradeshows, inbound telesales, and print advertising to generate interest in their product. Similarly, conventional systems fail to offer individuals or groups of individuals a platform by which to obtain from the prospect a commitment to a meeting. These and other problems exist.

Thus, what is needed is to provide incentives for both a prospect and those who would like to schedule a meeting with the prospect. What is further needed is to facilitate the meeting between the prospect and those who would like to schedule the meeting.

### SUMMARY OF THE INVENTION

Various systems, methods, and computer program products are described for mediating sales of meeting times. For example, a method may include receiving an indication of a meeting for sale and a sale parameter. In some implementations of the invention, the meeting for sale includes a meeting with a party of interest for a specified period of time and the sale parameter describes the meeting for sale. In some implementations of the invention, the method may include communicating the meeting for sale and the sale parameter. In some implementations of the invention, the method may include receiving an offer to purchase the meeting for sale. In some implementations of the invention, the method may include determining whether the offer satisfies the sale parameter. In some implementations of the invention, the method may include facilitating the meeting with the party of interest when the offer satisfies the sale parameter.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 is a block diagram illustrating a system for providing a meeting time marketplace, according to various implementations of the invention.

FIG. 2 is a block diagram illustrating various services offered by marketplace server, according to various implementations of the invention.

FIG. 3 is a block diagram illustrating buyer interaction points with an auction-style meeting time marketplace, according to various implementations of the invention.

FIG. 4 is a block diagram illustrating seller interaction points with a meeting marketplace, according to various implementations of the invention.

FIG. 5 is a flow diagram illustrating an example of a process for providing a meeting time marketplace, according to various implementations of the invention.

FIG. 6 is a flow diagram illustrating an example of a process for providing a market for buying and selling meeting times, according to various implementations of the invention.

### DETAILED DESCRIPTION OF THE INVENTION

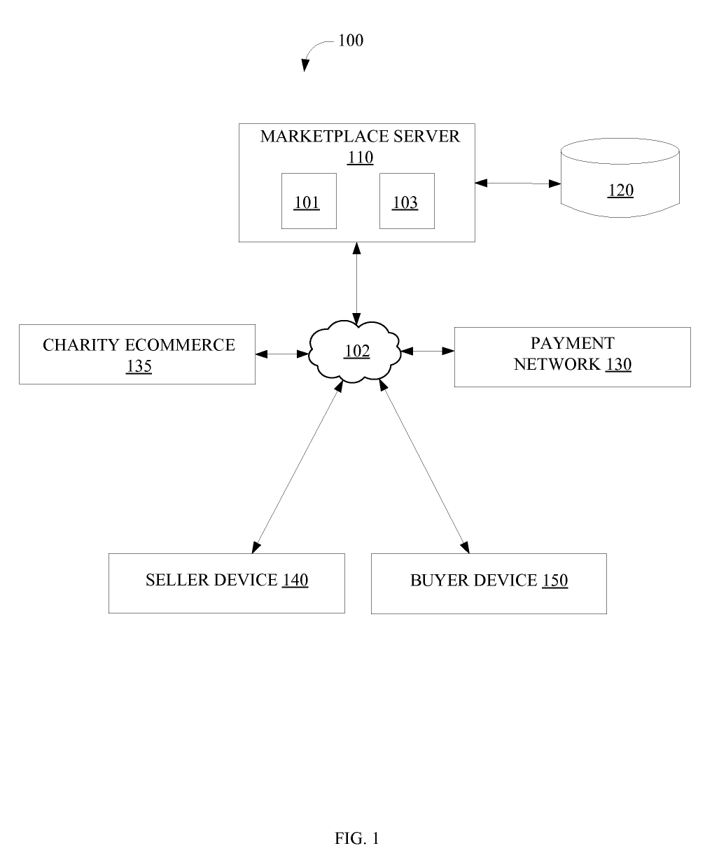

FIG. 1 is a block diagram illustrating a system 100 for providing a meeting time marketplace, according to various implementations of the invention. According to various implementations of the invention, system 100 may allow a corporation, third party, or individual to sell a meeting time with a party of interest to a buyer willing to purchase a specified time period in which to meet with the party of interest. In some implementations, the seller is the same entity or individual as the party of interest while in other cases the seller is a different entity or individual. Accordingly, as used herein, “seller” may include the party of interest or an entity/individual separate from the party of interest. System 100 may therefore allow a seller (whether or not the seller is the party of interest willing to meet with buyers of meeting times) to sell meeting times to buyers who wish to have a meeting with the party of interest.

For example and without limitation, the seller may include a corporation that sells executive or other employee meeting times, an individual such as an executive or celebrity willing sell meeting times, a third party selling meeting times of others, or a group of individuals. The buyer may include an individual, group of individuals, or corporation wishing to meet with the seller. In some cases, the buyer may wish to have the meeting in order to pitch a sale or otherwise market a product or service to the seller, who may be a corporation or executive that has particular subject matter expertise and/or may have an interest in the product or service but would not otherwise have an occasion to meet with the buyer. In some cases, the buyer may wish to simply meet with the seller who may be a celebrity. The buyer may wish to meet with the seller for other reasons as well.

Typically, though not necessarily, the seller or party of interest is incented to sell meeting times in exchange for contributions to fundraising entities such as charities or political campaigns. For example, a buyer may pay a particular price to meet with the seller or party of interest and all or portion of the proceeds of the sale may go to a charity chosen by the seller or party of interest. In this manner, the buyer benefits by achieving a meeting with the party of interest that would otherwise not be possible and the seller or party of interest benefits by donating time and therefore money to a charity. In some cases, the seller or party of interest may be incented to sell the meeting time by keeping all or a portion of the proceeds of the sale as well.

In some implementations of the invention, system 100 may be implemented as a Software as a Service (“SaaS”) web-based business-to-business enterprise corporate auction platform. In some implementations of the invention system 100 may be used to drive sales and business development, improve corporate human capital core competencies, and manage meeting scheduling and networking between BDMs or other buyers and executive level stakeholders or other sellers as part of the sales and procurement process. In this manner, system 100 facilitates access to quality meetings with executive level decision makers or other sellers.

In some implementations of the invention, system 100 may rewards both parties (buyer and seller) by coordinating meeting logistics based on subject matter compatibility. System 100 facilitates a collaborative environment that provides a 24×7×365 business auction solution for workforce prospecting with decision makers worldwide who are interested in taking a meeting to enhance the sales cycle. Stakeholders, other sellers, or party of interest will agree to the meeting based on their ability to deliver domain expertise, in exchange for one of many various forms of compensation such as, without limitation, donation to non-profit organizations, direct compensation, commission or equity. In this manner, system 100 may improve employee productivity, enhance personnel retention and reduce costs associated with overhead.

The foregoing are non-limiting examples. Other uses and implementations of system 100 with respect to various system components are described below.

According to various implementations of the invention, system 100 may include, but is not limited to, a marketplace server 110, a payment network 130, a charitable or fundraising electronic commerce payment device 135 (hereinafter, “charity ecommerce 135”), a seller device 140, and a buyer device 150. In some implementations of the invention, marketplace server 110 may include or otherwise be coupled to database 120. In some implementations of the invention, marketplace server 110, database 120, payment network 130, charity ecommerce 135, seller device 140, and buyer device 150 may be communicably coupled to one another via a network 102. Network 102 may include a Local Area Network, a Wide Area Network, a cellular communications network, a Public Switched Telephone Network, and/or other network or combination of networks. In some implementations of the invention, seller device 140 and buyer device 150 may each include, without limitation, a telephone, a computer, a smartphone, a cellular phone, a tablet computer, and/or other device that can be used to communicate with marketplace server 110. In some implementations of the invention, an Application Program Interface (“API”) may be used to access the marketplace server 110.

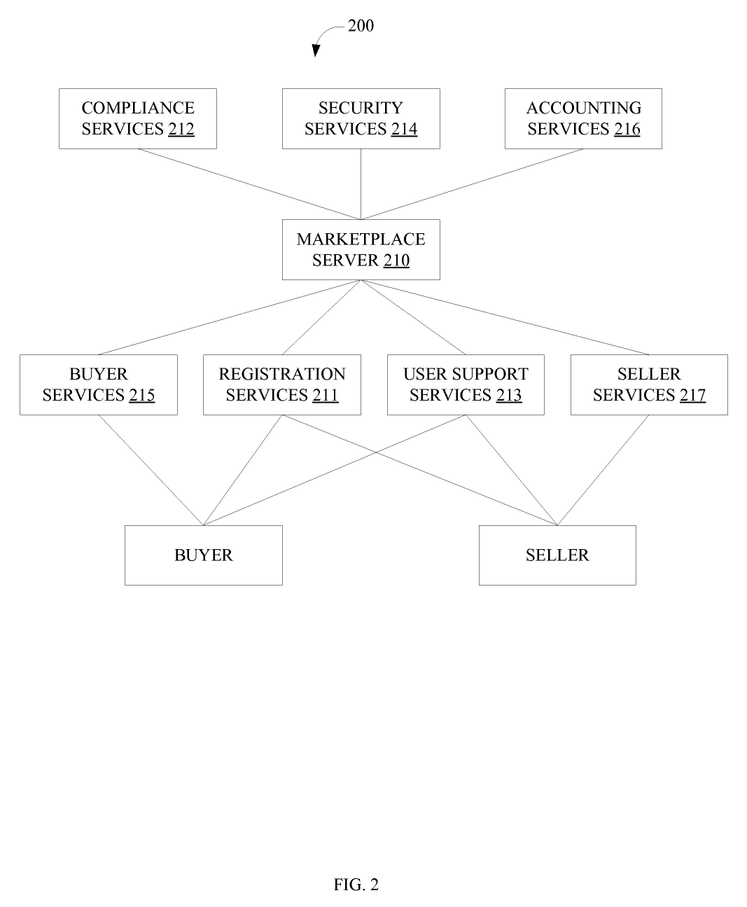

In some implementations of the invention, marketplace server 110 includes a variety of services (illustrated in more detail with respect to FIG. 2 below) associated with providing a marketplace for selling meeting times. Some of these services may include primarily user-facing services for interacting with users, such as buyers and sellers, while other services may include primarily internal services used to maintain marketplace server 110.

In some implementations of the invention, payment network 130 may include computing or other devices that facilitate payments across various payment networks, internet-based payments, or other payment systems that can be used to make funds transfers.

In some implementations of the invention, a seller may use seller device 140 in order to interact with one or more services of marketplace server 110. Similarly, in some implementations of the invention, a buyer may use buyer device 150 in order to interact with one or more services of marketplace server 110. In some implementations of the invention, each of seller device 140 and buyer device 150 may include software or instructions configuring the devices to communicate with marketplace server 110. For example, seller device 140 and buyer device 150 may each include browser software that allows the device to access a web page communicated by marketplace server 110. In some implementations, marketplace server 110 may provide software such as a mobile application that when loaded and installed on seller device 140 or buyer device 150 configures the device to communicate with marketplace server 110. In some implementations, marketplace server 110 may provide web services such as APIs that may be accessed by seller device 140 or buyer device 150 to communicate with marketplace server 110.

In some implementations of the invention, marketplace server 110 may receive an indication of a meeting for sale and a sale parameter. In some implementations of the invention, the meeting for sale is a meeting with a party of interest for a specified period of time and the sale parameter describes the meeting for sale. For example, the sale parameter may include, without limitation, a price, an auction sale, a reverse auction sale, a location, a meeting time, and/or a meeting duration. In some implementations of the invention, the listing (i.e., the meeting for sale and the sale parameter) may be received from the seller via a web page or other interface (such as, for example, a mobile application) of marketplace server 110.

In some implementations of the invention, marketplace server 110 may communicate the meeting for sale and the sale parameter. In some implementations of the invention, the listing may be communicated via a web page or other interface so that potential buyers may access the listing. In some implementations of the invention, the listing is communicated in response to a buyer requesting to view all listings by all sellers. In some implementations of the invention, the listing is communicated in response to a buyer requesting to view a particular listing such as by entering search terms or otherwise requesting other search functions to find the particular listing.

In some implementations of the invention, marketplace server 110 may receive an offer to purchase the meeting time. In some implementations of the invention, the offer to purchase may include an offer price that meets, exceeds, or is less than an offered sales price. In some implementations of the invention, the offer to purchase may include a bid in an auction to sell the meeting time. In some implementations of the invention, the bid may include a proxy bid that automatically increments the bid up to a maximum bid in response to competing bids. In some implementations of the invention, the offer to purchase may include a sealed offer to accept a seller's bid in a reverse auction.

In some implementations of the invention, marketplace server 110 may determine whether the offer satisfies the sale parameter. For example, when the meeting for sale is associated with a predefined price at which the meeting would be sold, the offer satisfies the sale parameter when the offer meets or exceeds the predefined price. In some implementations of the invention, marketplace server 110 may determine whether the offer satisfies the sale parameter by receiving an indication from the seller that the offer has been accepted. This may occur when, for example, the seller accepts a bid at auction, when the seller accepts an offer lower than the asking sales price, or other indication that the seller has accepted an offer.

In some implementations of the invention, marketplace server 110 may facilitate the meeting with the party of interest when the offer satisfies the sale parameter. In some implementations of the invention, the meeting may is associated with a meeting time, a meeting place, or a meeting duration of the sold meeting.

In some implementations of the invention, marketplace server 110 may provide event management services that allow the buyer and the seller to schedule the meeting based on a date, time, and/or location. In some implementations of the invention, the event management services may provide a calendar application used to schedule the meeting. In some implementations of the invention, the calendar application is available via the web page or other interface provided by marketplace server 110, via a mobile application or API accessed at seller device 140 or buyer device 150, and/or other interface accessible to the buyer and the seller.

In some implementations of the invention, marketplace server 110 may notify a user of various updates (such as whether the meeting has been sold described above) using various communication channels such as, without limitation, an email, a text message, an instant message, an automated or live phone call, or other channel that can communicate information to users. In some implementations of the invention, marketplace server 110 may determine whether a user is logged on to the system. In some implementations, when the user is logged on, marketplace server 110 may make a notification to the user on a display screen of a web page or other interface for which the user is logged on to the system. In some implementations, when the user is not logged on, marketplace server 110 may attempt other communication channels. As discussed herein, when various system components are described as “notifying” or “providing a notification” to a user (e.g., buyer, seller, or party of interest), such notification may take place as described above.

In some implementations of the invention, marketplace server 110 may cause a payment from the buyer associated with the offer to be made to facilitate the meeting with the party of interest. For example, marketplace server 110 may receive from the buyer a form of payment such as, for example, a credit card number, an online payment service, or a prepaid account associated with marketplace server 110. In some implementations, marketplace server 110 may process the form of payment via payment network 130.

In some implementations of the invention, marketplace server 110 may receive an indication of a charity or fundraising entity to which at least a portion of the payment is to be directed. In these implementations, marketplace server 110 may cause a payment to be made by automatically causing a contribution associated with the portion of the payment to the charity or fundraising campaign on behalf of the seller. In some implementations of the invention, marketplace server 110 may cause all or a portion of the payment to be donated to a charity indicated by the seller via charity ecommerce 135 or causing a check or other instrument to be sent to the charity or fundraising campaign. In some implementations of the invention, marketplace server 110 communicates directly with charity ecommerce 135 to complete the transaction/donation.

In some implementations of the invention, marketplace server 110 may credit an account of a seller of the meeting for sale with a credit equivalent to a dollar amount of the purchase money. For example, the account may be associated with marketplace server 110 and may be, without limitation, redeemable for cash by the seller, directed to a charity, and/or used to pay seller or other transaction fees.

In some implementations of the invention, marketplace server 110 may cause purchase money associated with the payment to be held in escrow. In these implementations, marketplace server 110 may cause the purchase money to be released from escrow when the meeting between the party of interest and the buyer has occurred. For example, when the buyer indicates, via a webpage or other interface, to marketplace server 110 that the meeting occurred, marketplace server 110 may cause the escrow funds to be provided to the seller, as described above.

In some implementations of the invention, marketplace server 110 may receive marketing material associated with the party of interest. The marketing materials may include, without limitation, a photograph, a job title, a job description, an employer name, a prior experience, or personal information of the party of interest. In these implementations, marketplace server 110 may communicate the marketing material to the buyer. In this manner prospective buyers of the meeting time may view and/or search the marketing materials in order to decide whether to place an offer to buy the meeting time for sale.

In some implementations of the invention, marketplace server 110 may receive various fees associated with providing a marketplace for meeting times. For example, the various fees may include, without limitation, a listing fee from the seller, a buying fee from the buyer, a sales transaction fee from the seller, a sales transaction fee from the buyer, a regular service fee from the seller, a regular service fee from the buyer, and/or advertising revenue for placing select ads on the web page or other interface. In some implementations of the invention, the various fees may be collected via payment network 130, from a user's account, and/or other source of funds.

According to various implementations of the invention, marketplace server 110 may include a processor 101, a memory 103, and/or other components that facilitate the functions of marketplace server 110 described herein. In some implementations of the invention, processor 101 includes one or more processors configured to perform various functions of marketplace server 110. In some implementations of the invention, memory 103 includes one or more tangible (i.e., non-transitory) computer readable media. Memory 103 may include one or more instructions that when executed by processor 101 configure processor 101 to perform the functions of marketplace server 110.

FIG. 2 is a block diagram illustrating various services offered by marketplace server 210, according to various implementations of the invention. In some implementations of the invention, user-facing services may include, without limitation, a registration service 211, a user support service 213, a buyer service 215, and a seller service 217. In some implementations of the invention, internal services may include, without limitation, a compliance service 212, a security service 214, and an accounting service 216.

In some implementations of the invention, registration service 211 may generate and maintain user accounts in response to user registrations. For example, a buyer wishing to purchase a meeting time may register with marketplace server 210 via registration service 211. In some implementations of the invention, registration service 211 may expose a web page or other interface that receives various user information such as, for example, a name, a mailing address, a phone number, an email address, an indication of whether the user is a buyer or seller (or both), a login/screen name, a password or other credentials, and/or other information associated with the user. In some implementations of the invention, registration service 211 may allow the user to review account details such as, without limitation, prior bids, prior sales, account activity, and/or other account information.

In some implementations of the invention, user support service 213 may provide support for users having difficulty accessing or using various services of marketplace server 210. For example, user support service 213 may expose a dynamic or static list of frequently asked questions for access by the user. In some implementations of the invention, user support service 213 may provide a user support interface for a live agent who directly interacts with the user. For example, the user may call (or email, chat, etc.) into a helpline, where the live agent assists the user using the user support interface. In some implementations of the invention, user support service 213 may sanction users for violations of user policies.

In some implementations of the invention, buyer service 215 may provide the buyer with various functions to interface with marketplace server 210. For example, buyer service 215 may, without limitation, communicate meeting times for sale, receive buyer bids or offers, notify buyers of the outcome of bids or offers, provide notification or alerts regarding meeting times for sale, allow buyers to access reviews from sellers, allow buyers to provide reviews of sellers, and/or perform other functions related to buying meeting times.

In some implementations of the invention, seller service 217 may provide the seller with various functions to interface with marketplace server 210. For example, seller service 215 may, without limitation, receive meeting times for sale from sellers, receive sale parameters that specify sale conditions (such as price, location, charitable contribution, and amount of time), notify sellers of sale progress, allow sellers to access reviews from buyers, allow sellers to provide reviews of buyers, and/or perform other functions related to selling meeting times.

In some implementations of the invention, compliance service 212 may ensure compliance by users of user policies such as, for example, attempting to sell duplicate meeting times, appropriateness of sale information or reviews of other users, and/or other user policies. In some implementations of the invention, compliance service 212 may ensure compliance with business policies that corporations or other entities may have regarding their employees. For example, a corporation may not wish their employees to receive money as an officer of the corporation in exchange for meeting with buyers. In this example, the corporation may require such money to go to a charity. As such, in some implementations, compliance service 212 may use configurable rules to set user and/or business policies.

In some implementations of the invention, security service 214 may be used to report on, monitor, or ensure security associated with marketplace server 210. For example and without limitation, security service 214 may be used by security guards or personnel who secure a real estate asset, information technology personnel who secure a computational asset (such as a network or a server device), and/or security personnel associated with the buyer or seller (such as bodyguards and online reputation monitoring personnel).

In some implementations of the invention, accounting service 216 may be used to view financial statistics and perform accounting functions associated with marketplace server 210. For example, an accountant or other individual may use accounting service 216 to generate financial reports, update a billing cycle, set fees for users (such as seller fees associated with listing meeting times for sale and/or buyer fees associated with buying or bidding on meeting times for sale), update user restrictions, and/or perform other accounting/financial tasks. In some implementations of the invention, user restrictions may include a maximum amount and/or time that a user may be overdue in their bills (whether user fees or money associated with purchases). For example, if a user is overdue by more than 30 days, the user may be prevented from placing bids/offers or listing further meetings for sale.

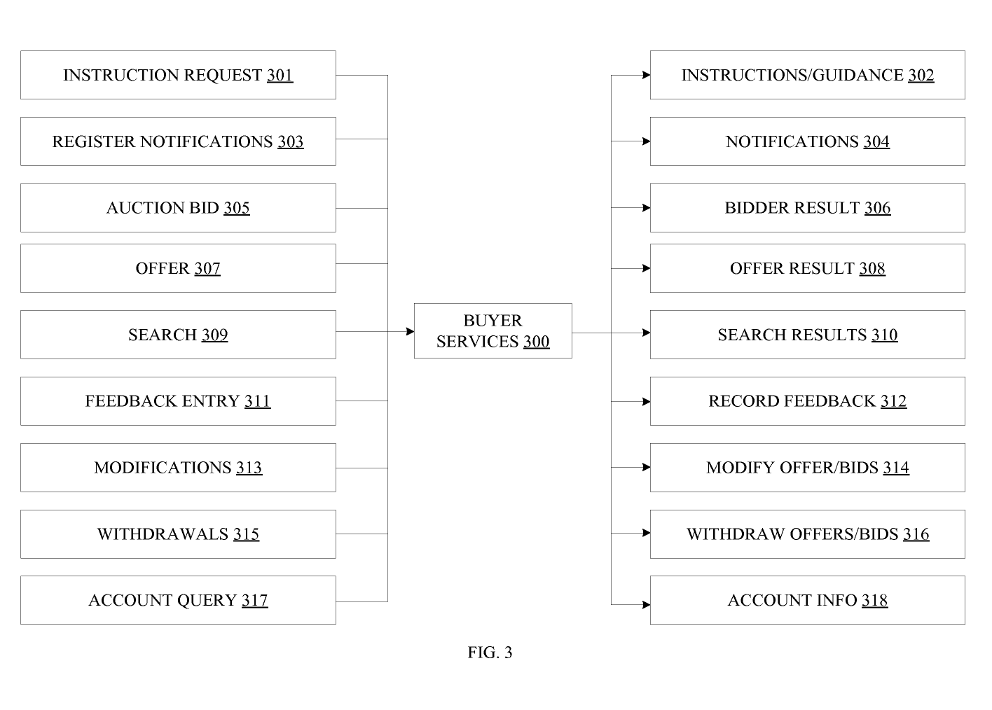

FIG. 3 is a block diagram illustrating buyer interaction points with buyer services 300, according to various implementations of the invention. In some implementations of the invention, buyer services 300 may receive a request for instructions or guidelines 301. In response, buyer services may provide the instruction or guidelines 302 that inform the buyer of rules or instruction how to place offers/bids.

In some implementations of the invention, buyer services 300 may receive a notification registration 303, which may include a request from a buyer to be notified when a particular meeting for sale is available. For example, the buyer may input criteria for a meeting for sale such as, without limitation, a company, a title, a location, or other criteria in which the buyer is interested. In response to notification registration 303, buyer services 300 may periodically search meetings for sale for the criteria. In some implementations of the invention, when a meeting for sale fits the criteria, buyer services 300 may notify the buyer of the matching meeting for sale.

In some implementations of the invention, buyer services 300 may receive an auction bid 305, which may include a bid or a proxy bid. In response, buyer services 300 may enter auction bid 305 and notify the buyer of the results 306 of the bid such as whether auction bid 305 won or was outbid. In some implementations of the auction may be cancelled. In these implementations, buyer services 300 may notify the buyer of such cancellation.

In some implementations of the invention, buyer services 300 may receive an offer 307, which may include an offer by a buyer to purchase a meeting for sale at, above, or below a requested sale price. In response, buyer services 300 may enter offer 307 and notify the buyer of the results of the offer 308 such as whether the offer was sufficient or otherwise accepted by the seller. In some implementations of the meeting for sale may be cancelled prior to cancelling the listing. In these implementations, buyer services 300 may notify the buyer of such cancellation.

In some implementations of the invention, buyer services 300 may receive a search request 309 that requests meetings for sale according to search criteria and/or restrictions. In some implementations of the invention, the search criteria may specify, without limitation, a sale category, a sale number, a keyword, a seller name, a location, a company, a time, or other criteria to search for meetings for sale. In some implementations of the invention, search restrictions may include, without limitation, all sales, all open sales, all new sales, all closing sales, and all closed sales. In response, buyer services 300 may communicate a search results 310 of meetings for sale that meet the criteria and/or restrictions. In some implementations of the invention, search results 310 may include or otherwise have links to additional information about sellers included in the results such as a profile, a title, feedback given to the seller from other buyers, and/or other information about the seller.

In some implementations of the invention, search request 309 may include a request to list all meetings for sale so that the buyer may navigate all listings. In these implementations, search results 310 may include all listings.

In some implementations of the invention, buyer services 300 may receive feedback 311 on a seller. Feedback 311 may be from a buyer who has experience with the seller. In response, buyer services 300 may enter feedback 311, which may be accessible to other users as well as the seller.

In some implementations of the invention, buyer services 300 may receive modifications 313, which may include, without limitation, changes to a bid, changes to an offer, or other modifications related to a bid or offer from a buyer. In response, buyer services 300 may modify offers/bids 314. In these implementations, the seller may be notified of the modifications.

In some implementations of the invention, buyer services 300 may receive withdrawals 315, which may include, without limitation, withdrawal of an offer or bid. In response, buyer services 300 may withdraw offers/bids 316. In these implementations, the seller may be notified of the withdrawal.

In some implementations of the invention, buyer services 300 may receive an account query 317, which may seek information regarding a buyer's account. In response, buyer services 300 may provide account information 318 of the buyer, which may include, without limitation, prior bids/offers, prior meeting purchases, current bids/offers, reviews from sellers of the buyer, account profiles, an account balance (such as an amount owed for purchases or fees), or other account information of the buyer. In some implementations of the invention, the buyer and the seller may each specify a particular channel (e.g., email, text message, etc.) by which they would like to receive notifications such as electronic alerts of potential auctions of interest to either party.

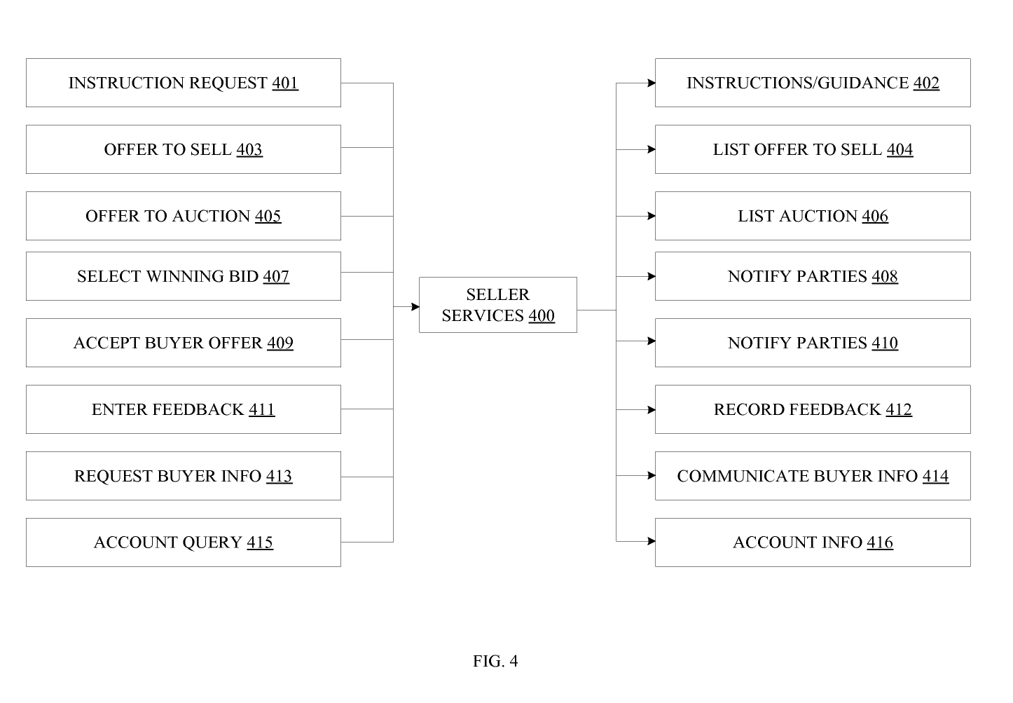

FIG. 4 is a block diagram 400 illustrating seller interaction points with seller services 417, according to various implementations of the invention. In some implementations of the invention, seller services 400 may receive a request for instructions or guidelines 401. In response, seller services 400 may provide instruction or guidelines 402 that inform the seller of rules or instruction how to place offer for sale meeting times, how to accept offers to buy, how to handle accepted offers to sell, and/or other instruction related to selling a meeting time.

In some implementations of the invention, seller services 400 may receive an offer to sell a meeting time 403. In some implementations, offer to sell a meeting time 403 may include a sale parameter such as a price, a location, a seller profile, or other information associated with a meeting time offer for sale. In response, seller services 400 may store the offer and generate a listing 405 such that buyers may view or otherwise access the listing. In some implementations, seller services 400 may notify the seller that the listing has been generated.

In some implementations of the invention, seller services 400 may receive an auction listing 405, which may include, without limitation, a starting bid price, a minimum offer to consider, an auction start or end time, and/or other auction information. In response, seller services 400 may publish an auction listing such that buyers may bid on or otherwise access auction listing 405.

In some implementations of the invention, seller services 400 may receive a selection of a winning bid 407 in an auction. The selection may indicate from a seller of a meeting time that a particular bid to buy the meeting time is acceptable. In response, seller services 400 may notify 408 both parties of the selection.

In some implementations of the invention, seller services 400 may receive a selection of an offer to buy 409. The selection may indicate from a seller of a meeting time that a particular offer to buy the meeting time is acceptable. In response, seller services 400 may notify 410 both parties of the selection. In some implementations, the selection 409 may include a counter-offer, in which case, seller services 400 may communicate the counter-offer to the buyer. This process may continue until either the buyer or seller terminate negotiations (via seller services 400 or buyer services 300 illustrated in FIG. 3), until an agreement is reached, or other suitable end point.

In some implementations of the invention, seller services 400 may receive feedback 411 on a buyer. Feedback 411 may be from a seller who has experience with the buyer. In response, seller services 400 may enter feedback 411, which may be accessible to other users and may include the buyer.

In some implementations of the invention, seller services 400 may a request 413 for feedback on a buyer. For example, the seller may wish to view feedback about the buyer from other sellers before making a decision whether to accept an offer or bid from the buyer. In response, seller services 400 may provide feedback 414, which may include other information on the buyer including, but not limited to, prior bids/offers/purchases, buyer profile, or other information associated with the buyer.

In some implementations of the invention, seller services 400 may an account query 415, which may seek information regarding a seller's account. In response, seller services 400 may provide account information 416 of the buyer, which may include, without limitation, prior listings for sale, prior sold listings, current listings for sale, reviews from buyers of the seller, account profiles, an account balance (such as an amount owed for purchases or fees), or other account information of the seller.

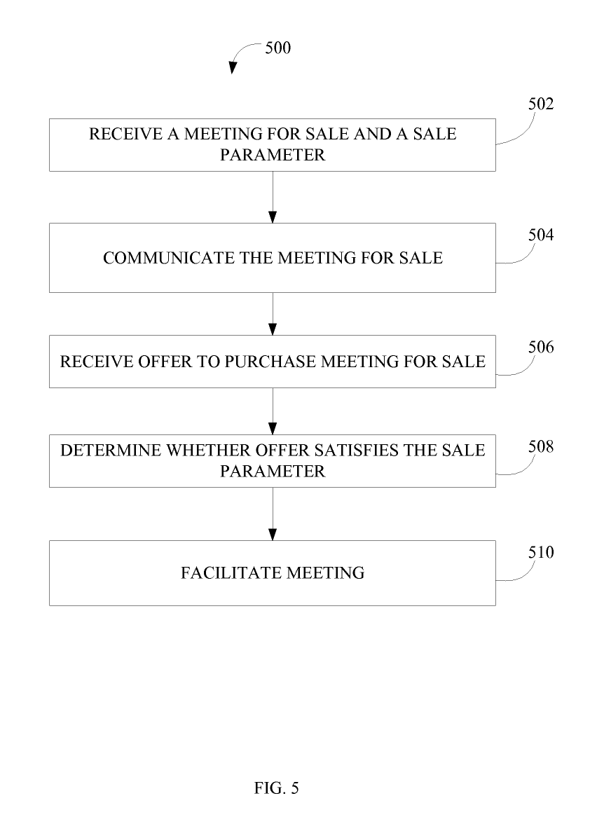

FIG. 5 is a flow diagram illustrating an example of a process 500 for providing a meeting time marketplace, according to various implementations of the invention. The various processing operations and/or data flows depicted in FIG. 5 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 502, process 500 may include receiving an indication of a meeting for sale by the seller and a sale parameter. In some implementations of the invention, the meeting for sale includes a meeting with the seller for a specified period of time and the sale parameter describes the meeting for sale. In some implementations of the invention, in an operation 504, process 500 may include communicating the meeting for sale and the sale parameter. In some implementations of the invention, in an operation 506, process 500 may include receiving an offer to purchase the meeting time. In some implementations of the invention, in an operation 508, process 500 may include determining whether the offer satisfies the sale parameter. In some implementations of the invention, in an operation 510, process 500 may include notifying the buyer and the seller that the meeting for sale is sold when the offer satisfies the sale parameter.

According to various implementations of the invention, process 500 may be implemented using a computing device configured to perform process 500, such as marketplace server 110 illustrated in FIG. 1.

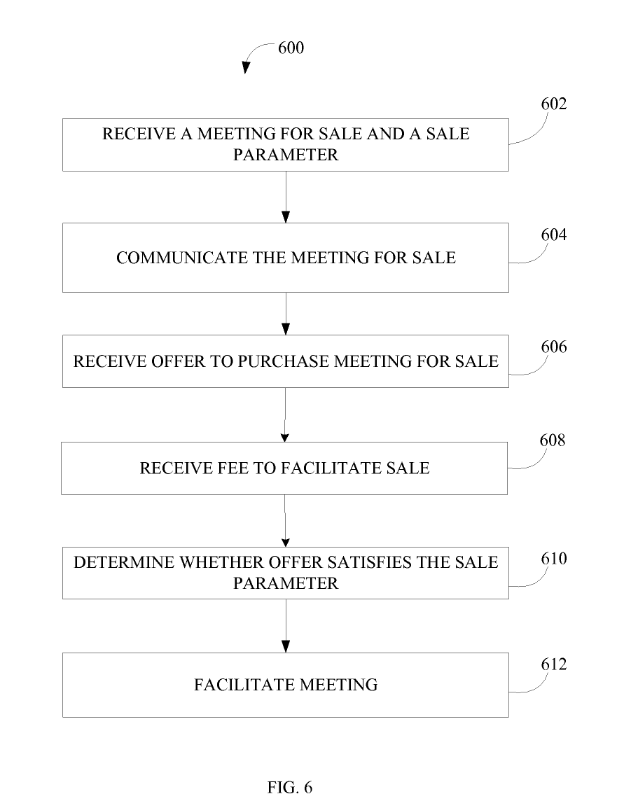

FIG. 6 is a flow diagram illustrating an example of a process 600 for providing a market for buying and selling meeting times, according to various implementations of the invention.

In some implementations of the invention, in an operation 602, process 600 may include receiving an offer to sell a meeting time by a seller and a sale parameter. In some implementations of the invention, the meeting for sale includes a meeting with the seller for a specified period of time and the sale parameter describes the meeting for sale. In some implementations of the invention, in an operation 604, process 600 may include communicating the meeting for sale and the sale parameter. In some implementations of the invention, in an operation 606, process 600 may include receiving an offer to purchase the meeting time. In some implementations of the invention, in an operation 608, process 600 may include receiving a fee to facilitate the sales transaction, listing fee from the seller, a buying fee from the buyer, a sales transaction fee from the seller, a sales transaction fee from the buyer, a regular service fee from the seller, or a regular service fee from the buyer. In some implementations of the invention, in an operation 610, process 600 may include determining whether the offer satisfies the sale parameter. In some implementations of the invention, in an operation 612, process 600 may include facilitating the sales transaction between the buyer and the seller when the offer satisfies the sale parameter.

Implementations of the invention may be made in hardware, firmware, software, or any suitable combination thereof. Implementations of the invention may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer-implemented method for mediating sales of meeting times, comprising:
receiving, by a computing device, an indication of a meeting for sale and a sale parameter, wherein the meeting for sale comprises a meeting with a party of interest for a specified period of time and the sale parameter describes the meeting for sale;
communicating, by the computing device, the meeting for sale and the sale parameter;
receiving, by the computing device, an offer to purchase the meeting for sale;
determining, by the computing device, whether the offer satisfies the sale parameter; and
facilitating, by the computing device, the meeting with the party of interest when the offer satisfies the sale parameter.

2. The computer-implemented method of claim 1, further comprising:
causing, by the computing device, a payment from the buyer associated with the offer to be made to facilitate the meeting with the party of interest.

3. The computer-implemented method of claim 2, further comprising:
receiving, by the computing device, an indication of a charity or fundraising campaign to which at least a portion of the payment is to be directed,
wherein causing a payment comprises causing a contribution associated with the portion of the payment to the charity or fundraising campaign.

4. The computer-implemented method of claim 2, wherein facilitating a payment comprises crediting an account of a seller of the meeting for sale with a credit equivalent to a dollar amount of the payment.

5. The computer-implemented method of claim 2, further comprising:
causing, by the computing device, purchase money associated with the payment to be held in escrow; and
causing, by the computing device, the purchase money to be released from escrow when the meeting between the party of interest and the buyer has occurred.

6. The computer-implemented method of claim 1, wherein the sale parameter comprises a bid auction and the offer comprises a bid, wherein determining whether the offer satisfies the sale parameter comprises determining whether the bid has been accepted.

7. The computer-implemented method of claim 6, wherein the offer further comprises a proxy bid that escalates in predefined increments up to a maximum.

8. The computer-implemented method of claim 1, wherein the sale parameter comprises a reverse bid auction, wherein determining whether the offer satisfies the sale parameter comprises determining whether the buyer accepted a bid by the seller.

9. The computer-implemented method of claim 1, wherein the sale parameter comprises a fixed sales price and wherein determining whether the offer satisfies the sale parameter comprises determining whether the offer is at or above the fixed sales price.

10. The computer-implemented method of claim 1, further comprising:
receiving, by the computing device, marketing material associated with the party of interest; and
communicating, by the computing device, the marketing material to the buyer.

11. The computer-implemented method of claim 10, wherein receiving marketing material comprises receiving a photograph, a job title, a job description, an employer name, a prior experience, or personal information of the party of interest.

12. The computer-implemented method of claim 1, wherein communicating the meeting for sale further comprises:
communicating a time or a location of the meeting for sale.

13. The computer-implemented method of claim 1, further comprising:
receiving, by the computing device, a search request from the buyer, wherein the search request seeks a potential party of interest in which the buyer may be interested, and wherein the communicated meeting time results from the search request.

14. The computer-implemented method of claim 1, wherein a seller of the meeting for sale comprises the party of interest, a third party separate from the party of interest, or an employer of the party of interest.

15. A system for mediating sales of meeting times, comprising:
a computing device configured to:
receive an indication of a meeting for sale and a sale parameter, wherein the meeting for sale comprises a meeting with a party of interest for a specified period of time and the sale parameter describes the meeting for sale;
communicate the meeting for sale and the sale parameter;
receive an offer to purchase the meeting for sale;
determine whether the offer satisfies the sale parameter; and
facilitate the meeting with the party of interest when the offer satisfies the sale parameter.

16. The system of claim 15, the computing device further configured to:
cause a payment from the buyer associated with the offer to be made to facilitate the meeting with the party of interest.

17. The system of claim 16, the computing device further configured to:
receive an indication of a charity or fundraising campaign to which at least a portion of the payment is to be directed; and
cause a contribution associated with the portion of the payment to the charity or fundraising campaign.

18. The system of claim 16, the computing device further configured to:
credit an account of a seller of the meeting for sale with a credit equivalent to a dollar amount of the payment.

19. The system of claim 16, the computing device further configured to:
cause purchase money associated with the payment to be held in escrow; and
cause the purchase money to be released from escrow to the seller when the meeting between the party of interest and the buyer has occurred.

20. The system of claim 15, wherein the sale parameter comprises a bid auction and the offer comprises a bid, and wherein the computing device is further configured to:
determine whether the bid has been accepted.

21. The system of claim 20, wherein the offer further comprises a proxy bid that escalates in predefined increments up to a maximum.

22. The system of claim 15, wherein the sale parameter comprises a reverse bid auction, and wherein the computing device is further configured to: determine whether the buyer accepted a bid by the seller.

23. The system of claim 15, wherein the sale parameter comprises a fixed sales price and wherein the computing device is further configured to: determine whether the offer is at or above the fixed sales price.

24. The system of claim 15, the computing device further configured to:
receive marketing material associated with the party of interest; and
communicate the marketing material to the buyer.

25. The system of claim 24, wherein the marketing material comprises a photograph, a job title, a job description, an employer name, a prior experience, or personal information of the party of interest.

26. The system of claim 15, the computing device further configured to:
communicate a time or a location of the meeting for sale.

27. The system of claim 15, the computing device further configured to:
receive a search request from the buyer, wherein the search request seeks a potential party of interest in which the buyer may be interested, and wherein the communicated meeting time results from the search request.

28. The system of claim 15, wherein a seller of the meeting for sale comprises the party of interest, a third party separate from the party of interest, or an employer of the party of interest.

29. A method for providing a market for buying and selling meeting times, comprising:
receiving an offer to sell a meeting time and a sale parameter, wherein the meeting for sale comprises a meeting with a party of interest for a specified period of time and the sale parameter describes the meeting for sale;
communicating the meeting for sale and the sale parameter;
receiving an offer to purchase the meeting time;
receiving a fee to facilitate the sales transaction, listing fee from the seller, a buying fee from the buyer, a sales transaction fee from the seller, a sales transaction fee from the buyer, a regular service fee from the seller, a regular service fee from the buyer, or an advertising fee associated with listing the offer for sale;
determining whether the offer satisfies the sale parameter; and
facilitating the meeting with the party of interest when the offer satisfies the sale parameter.
